(19) United States
(12) Patent Application Publication
(10) Pub. No.: US 2010/0142538 A1
(43) Pub. Date: Jun. 10, 2010

(54) M2M data router

(75) Inventors: Matt Glover, Coppell, TX (US); Iain Shigeoka, Richardson, TX (US)

Correspondence Address: DOCKET CLERK, P.O. DRAWER 800889, DALLAS, TX, 75380, US

(73) Assignee: Enfora, Inc., Richardson, TX (US)

(21) Appl. No.: 12/316,001

(22) Filed: Dec. 9, 2008

(51) Int. Cl. H04L 12/56

(52) U.S. Cl. 370/400

(57) ABSTRACT

A router receives data packets from a remote M2M device and routes all or a portion of the data to one or more servers for further processing. Routing is determined based on the application layer data (data or data type) within the packet. For example, in a GPS tracking device, the data packet (or certain data within the packet) is routed to a first server when the data is of a first type or according to specific rule governing routing based upon some attribute.

### TECHNICAL FIELD

Generally, the invention relates to data routing, and, more particularly, the invention relates to optimizing data routing for Machine to Machine (M2M) applications.

### BACKGROUND

Wireless data networks provide standard Internet Protocol (IP) delivery of data from a carrier network to a client. Traditional data routers provide routing based solely upon IP header information. Traditional data routers do not designate more than one destination for a single packet, and they typically do not provide enhanced features for packet processing such as copying, splitting, and secure routing.

In addition, wireless data transfers are usually constrained by limited bandwidth in the wireless network. Traditional data routers do not optimize data transfers for this limited bandwidth, as all routing is based upon destination addresses. The optimization of data that is transmitted or received by a client will reduce the amount of data that is transferred and the cost of data transfers. Therefore, there is a need to optimize data routing.

### SUMMARY

In one embodiment, a system is disclosed that comprises a machine to machine (M2M) device and a M2M router in communication with the M2M device. The M2M router is programmed to route data from the M2M device based upon the contents of the data from the M2M device, and designed to categorize the data from the M2M device as one of wakeup, attention request, attention response, modem event, or other data. This system also comprises a server in communication with the M2M router that receives a packet from the M2M device and routes the packet based upon the categorized application data comprised within the packet to the server.

In a second embodiment, an apparatus is disclosed that comprises a memory in a M2M router, a processor in the M2M router that accesses the memory and the processor configured to store, retrieve, or execute a plurality of routing functions and a communication interface in the M2M router. The communication interface is coupled to the processor, and the communication interface receives a packet of information from a M2M device and interprets the application data within the packet. The M2M device routes the data within the packet according to the interpretation of the application data.

In yet another embodiment, a method is disclosed that comprises receiving a packet, analyzing the contents of the packet, and categorizing the packet. The category of the packet is determined by comparing the analyzed contents of the packet against a list of known categories of packets. This method further comprises determining a routing rule that corresponds to the determined category of the packet and routing the packet.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a block diagram illustrating one system of implementing an automated M2M update system (MDRS);

FIG. 2 is a block diagram of components in a data packet;

FIG. 3 is a block diagram of a network using a M2M router and a plurality of secure servers;

FIG. 4 is a block diagram of another embodiment of a network using a M2M router and a plurality of secure servers;

FIG. 5 is a flowchart of one method of routing a packet using security parameters in a data packet;

FIG. 6 is a block diagram of an exemplary general-purpose computer system suitable for implementing the several embodiments of the disclosure; and

FIG. 7 is a diagram of an M2M router.

### DETAILED DESCRIPTION

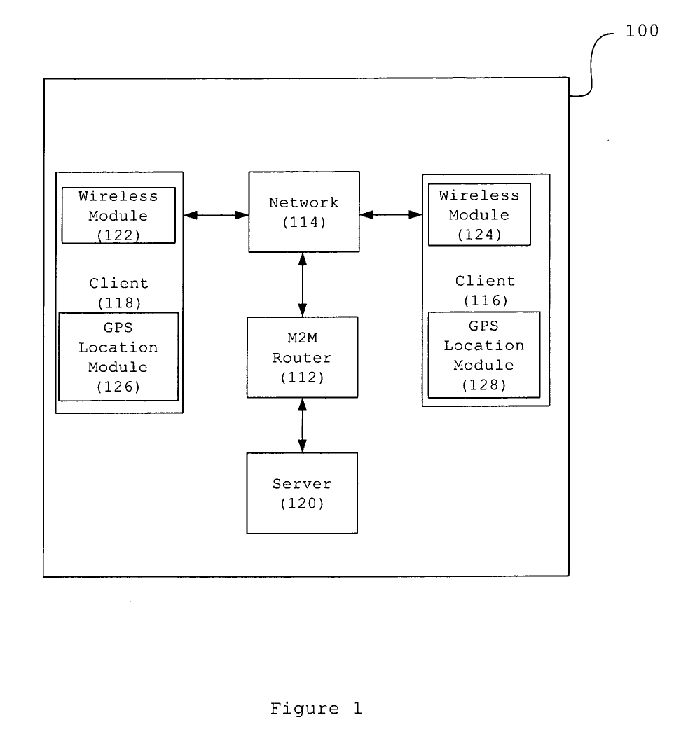

FIG. 1 is a block diagram illustrating one system of implementing a M2M data routing system (MDRS) 100. In one embodiment, M2M router 112 receives data from a client 118 and a client 116 through network 114 and routes the data to a server 120.

One of the features of M2M router 112 is that data is routed using application layer information obtained from a received data packet. The M2M router 112 examines data within an application layer of the data packet and dynamically determines how to route the entire data packet or part of the data packet. This application layer approach to routing allows the M2M router 112 to dynamically and securely route data, as will be discussed herein.

The MDRS 100 includes a GPS tracking device 104 and each client 116, 118. The GPS tracking device 104 includes a processor 122, a wireless network module 108 (such as a GSM/GPRS/EDGE modem), a GPS module 110, one or more sensors 126, memory 120, and a power source 130, such as a battery. The memory 120 may includes store various settings. The GPS tracking device 104 may include a real-time clock and other components for providing additional functionality. The one or more sensors 126 may include sensors that measure/sense motion, temperature, velocity, presence or absence of a particular element, or include other functionality for performing any other task.

Clients 116 and 118 may be any devices, including, but not limited to M2M devices. Clients 116, 118 each include a wireless module 122, 124 and a Global Positioning System (GPS) location module 126, 128. The wireless network modules 122, 124 clients 116, 118 may utilize any wireless technology including, but not limited to, code division multiple access (CDMA), global system for mobile (GSM) communications, worldwide interoperability for microwave access (WiMAX), or any other wireless standard. Through the wireless network modems 122, 124 the clients 116, 118 are able to communicate with other remote communication devices via an air interface. Through the coupling of the GSM/GPRS device to a wireless modem or radio, the M2M device can both obtain GPS data as well as transmit the GPS data wirelessly to a server. Various GPS tracking devices are available from Enfora, Inc. (Richardson, Tex.) under different part/model numbers, including GSM 2228, GSM 2218 and GSM 2238.

The MDRS 100 may also include various remote communications devices, such as a base station 112 and a host server 116. The GPS module 110 receives satellite communications from one or more GPS satellites 114 and calculates GPS position/location information. In a different embodiment, other location determining modules may be used, such as one that calculates position/location information using a method other than GPS satellites, such as position triangulation using one or more base stations or other reference points. The wireless network module 108 provides wireless communication functionality between the GPS tracking device 104 and the base station and/or host server 116, including transmitting position/location information, such as GPS data, to a remote device (e.g., host server 120).

Unlike conventional wireless devices, M2M devices generally do not have a user interface (UI) or a method for user data entry and these M2M devices may only have a power on or off mode. In addition, M2M devices are designed to automatically transmit data relating to a predefined set of criteria without user intervention, so M2M devices are generally designed without the ability to be easily configured by an end user.

Network 114 is any medium or network that is used to provide connectivity from a client to the M2M router. Examples of network 114 include, but are not limited to, a wireless network base station connected to the Internet, a wireless intranet or local network connection, or any other network connection.

Server 120 is a general purpose computing device that receives data through the M2M router 112 from the clients 116, 118. The server 120 may perform any function upon data received from a client, and it is contemplated that server 120 may perform a plurality of functions.

The M2M router 112 is a device capable of routing M2M data. The M2M router 112 can be implemented as a software server, a hardware server, or software that is executed on hardware. One of the innovative features of the M2M router 112 is that it performs application layer routing on M2M device data. As such, the M2M router 112 recognizes and understands the envelope and data formats of device data packets and performs intelligent, dynamic routing based on packet content and environmental conditions. As will be explained within this disclosure, the use of application layer router allows the M2M router 112 to efficiently route data to not just a single data destination, but rather securely route data to a plurality of destinations (including the server 120).

It is understood that the processing requirements of the M2M router 112 may be higher than the processing requirements of a conventional data router. This may be a result of the M2M router 112 analyzing contents of the data packet rather than simply forwarding data according to an IP header. One of the innovations of the present disclosure is that the M2M router 112 recognizes the tradeoff between processing requirements and data routing efficiency. The optimization of data routing therefore is based upon not only the routing of a data packet, but also the content of the data packet.

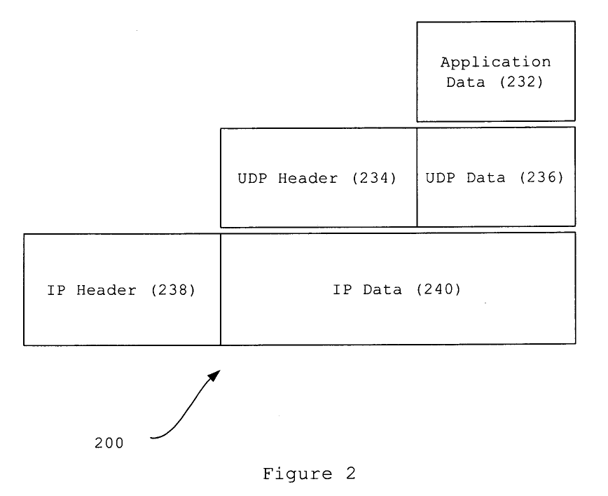

FIG. 2 is an illustration of the application layers of a standard IP packet 200. The standard IP packet includes an IP header 238 and IP data 240. Located within the IP data 240 are the user datagram protocol (UDP) header 234 and UDP data 236. Within the UDP data 236 is application data 232. The M2M router 112 provides the ability to define how data is routed to end points within a network using application data 232.

The application data 232 is extracted from the UDP data 236 and is classified based upon the content of the application data 232. For instance, the application data 232 may include GPS position information. The M2M router 112 recognizes the GPS position information in the application data 232 and forwards the application data 232 based upon how the M2M router 112 is programmed to handle GPS position information.

It is expressly understood that the M2M router 112 may extract some or all of the application data 232 from the UDP data 236, IP data 240, or other source and forward the application data 232 (or portions thereof) by either using the existing IP header and IP payload or encapsulating the application data 232 in a new data packet with a new IP header and new IP payload.

It is understood that data may be routed to an M2M router 112 by using the M2M router 112 as the destination IP address, or the M2M router 112 may be placed at a gateway that intercepts packets as they move through the network. Therefore, the M2M router may function as an intermediary node (e.g., a node placed in between a source and destination that intercepts packets) or a destination node (e.g., a node that is used as the destination as designated by an IP header), or both (intermediary for certain communications and a destination node for other communications).

The M2M router 112 is similar to IP-based routers and performs the same role as other application layer routers such as HTTP routers, VOIP routers, etc., and typically includes similar components and functionality. However, unlike conventional routers that route data based upon IP header 238, M2M router 112 routes data based upon application data 232. Application data 232 is, in some embodiments, referred to as payload data. Using the data to route packets, rather than the header information to route packets, ensures that data is routed to the appropriate destination. Using this approach, data may be split, copied, and securely handled as will be discussed herein.

An alternative embodiment (not shown) would include at least one additional M2M router, where data can be transcieved to and from a plurality of routers. This provides decision-making capabilities for a plurality of nodes. This can be expanded to multiple M2M router connections in a similar manner as implemented in traditional IP routers. Through this method, data that comes into the M2M router 112 may be split, copied, or routed in a plurality of ways through a plurality of M2M routers based upon the application data 232.

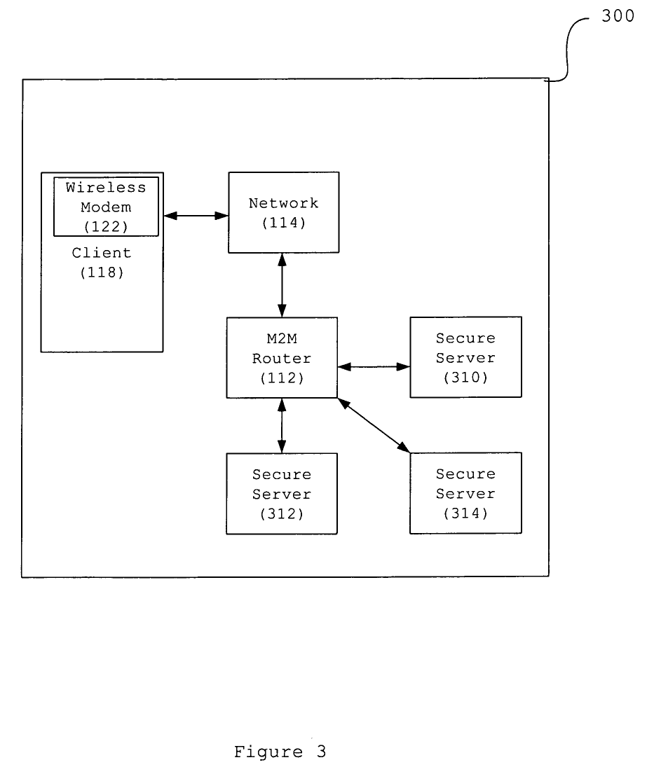

FIG. 3 illustrates a block diagram 300 of one embodiment where the M2M router 112 provides application data level routing and security. The M2M router 112 addresses the area of security by providing router-level connection security. In the embodiment shown in FIG. 3, a plurality of secure servers 310, 312, and 314 are communicatively coupled to M2M router 112. Each secure server 310, 312, and 314 may be responsible for one or more types of information. For instance, if client 118 transmits information related to the location of a device, the location information may be routed or relayed to the first secure server 310. If client 118 transmits information related to the status of a device, the information may be routed or relayed to the second secure server 312. If client 118 transmits information related to the environmental parameters (temperature, etc.) of a device, the information may be routed or relayed to third secure server 314. Through an interpretation of the data or data type within the application data 232 of the data packet received from client 118, all or portions of the data may be routed to an appropriate destination. It is further understood that the M2M router 112 may further route information to a plurality of unsecure servers (not shown) when the information in the application data 232 is designated by the M2M router as public information.

Interpretation of the data within the application layer 232 of the packet from client 118 may require specific information relating to the data format of a M2M device. The M2M router 112 may be able to interpret data based upon fields (e.g., the position of data within the application layer), field markers (e.g., information within the application, such as the information within a markup language document) or any other method of formatting data. The application data 232 transmitted by an M2M device is generally not interpretable by the M2M router 112 without the M2M router 112 being preprogrammed to interpret the M2M device data.

One of the innovative features of the M2M router 112 is that routing rules may be stored in memory 820 that are specific to defined data types can be defined and implemented that designate how application data 232 will be routed. These rules will facilitate the delivery of data based on the type of data within the packet.

For example, when data from client 118 is received by the M2M router 112, the M2M router 112 will inspect the data and can determine how to route the data. If the application data 232 received is a first type of data (e.g., provisioning data) the M2M router 112 may deliver data to specific secure server (e.g. first secure server 310). If the data inspected is not provisioning data, it may be delivered to a second server (e.g. second secure server 312) for processing.

There are a number of data packet types that can be identified for the application of specific routing rules depending on the particular operation of the M2M device. The following list is an example of existing packet types that may be in the application data 232 such as for the GPS tracking device 104:
Wakeup (heartbeat)
AT request
AT response
Unsolicited (push) message (Events)

Within the event type of packets, the following fields are potentially included in the event packet and can be used to make decisions on how to route the data:

User specified number

Modem ID

Input event

Date

Time

Status

Satellite count

Latitude

Longitude

Speed

Heading

Altitude

Odometer

Real-time clock

Short Modem ID

Battery level

For example, location data (lat/lon) can be examined and routed to a specific destination based on the actual coordinates.

The M2M router 112 provides several methods in which data can be routed based on the specific content. These methods include, but are not limited to, a switch method, split method, and a copy method.

The switch method refers to the ability to dynamically change the routing from one destination (such as the M2M router) to another based on the data type defined in the application data 232. This capability would be used to change the way data is routed based on multiple types of data that can potentially be received by the M2M router 112.

The split method breaks data into various logical groups for routing based on the types of data received within the application data 232. The split method would facilitate efficient routing of data to targeted destinations based on data that is received. It is understood that this would save data bandwidth relating to data both sent to a client 118 as well as data sent to one of the plurality of secure servers 310, 312, and 314.

The copy method transmits the same data to a plurality of destinations. This function could be used for routing data to multiple destinations to create a redundancy based on the type of data received.

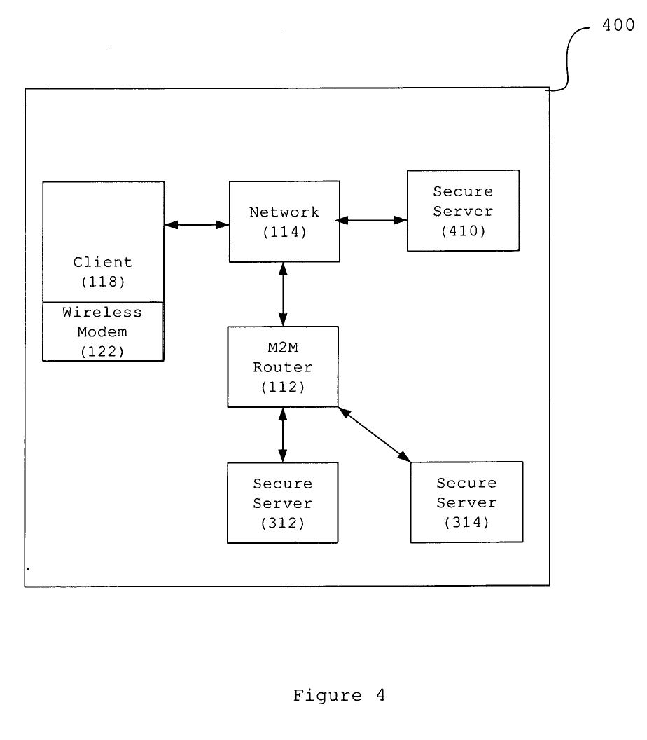

FIG. 4 is a block diagram that is similar to the diagram shown in FIG. 3, except that the secure server 410 has replaced the secure server 310. In this embodiment, secure server 410 may be connected to the M2M router 112 through the network 114. In some methods, such as the copy method, it may be advantageous to create data redundancy at a remote location. Since the M2M router 112 can intelligently split, copy, or switch data, the information transmitted to the secure server 410 only relates to the data for which redundancy is desired. Existing bandwidth is then minimized while preserving and protecting desired data.

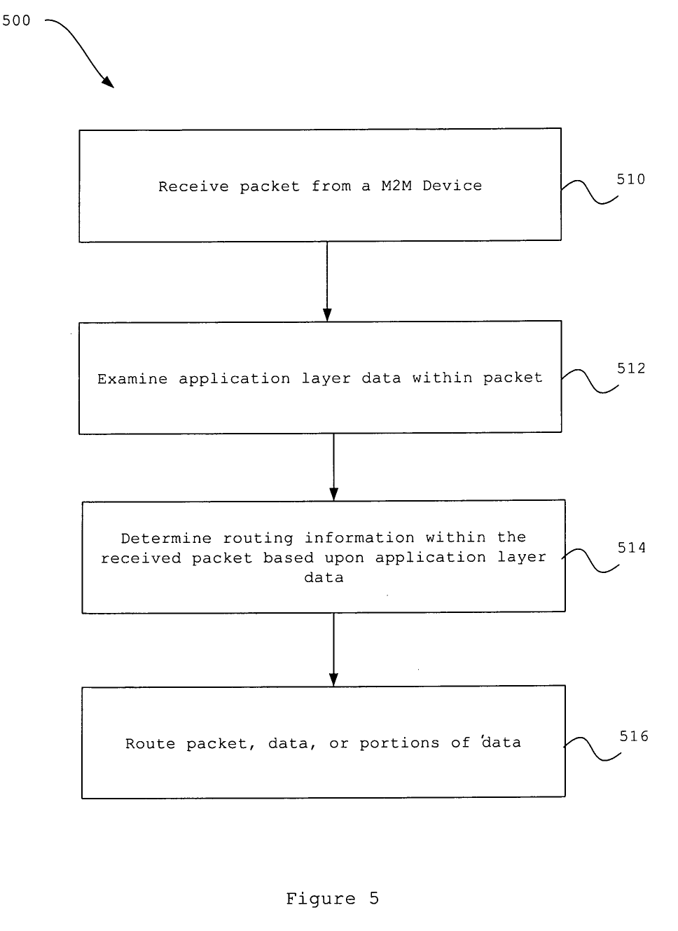

FIG. 5 is a block diagram illustrating a method 500 of routing data received at the M2M router 112. In this embodiment, the M2M router 112 receives a packet from an M2M device (Block 510). The M2M router 112 examines the application data 232 within the received data packet 200 (Block 512). The M2M router 112 determines the routing parameters that will be applied when routing the packet and data (Block 514). These routing parameters be based on security parameter, routing mode, and/or data content or data type and involve various methods or modes of routing. Based upon the routing parameters, the M2M router 112 routes the packet, data, or portions thereof (Block 516).

The rules that the M2M router 112 uses to route data may, in some embodiments, be based upon rules stored in a table in the M2M router 112. The M2M router may receive packet, data, or portions thereof, then lookup within a table to determine how to route the packet. Such a table may be a table with two columns that link data type to routing instructions. This table may also include additional information about default routing rules. This table may be stored in memory 820, as will be discussed below.

The use of security parameters may be implemented in any way known to one skilled in the art. One simple example of the use of security parameters is the assigning of a security level to data or data types within a packet. For instance, the M2M router 112 may know that certain application data (e.g., location of a unit) has a particular security level (1). The M2M router 112 may also know that certain application data (e.g., content of items being shipped with a device) may have a high security level (2). The location of a device may be freely transmitted, but information relating to the content may not. In this way, the information-relating to the content may be stripped or removed prior to transmission, preventing that information from being routed or retransmitted to a server.

The M2M router 112 determines the routing mode for the packet based upon the content of the application data type and the settings within the M2M router 112. This routing mode may be a copy mode, a switch mode, or a split mode. For example, the M2M router may receive a packet; determine the type of the packet, then lookup in a table for instructions on how to deal with the packet. The instructions that correspond to the packet may include copying the packet, switching the packet, or splitting the packet. Table 1 shown below is an example of the table that may be stored in the M2M router:

TABLE 1

| Event in Application Data | Routing Instructions |
|---|---|
| AT response | Secure Route to A |
| Unsolicited (push) message (Events) | Split to A and B |

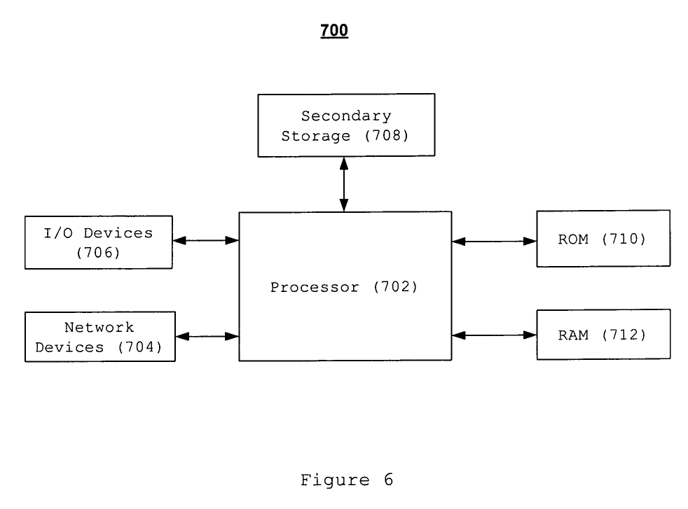

Servers 120, 310, 312, 314, 410, described above may be implemented on any computer system with sufficient processing power, memory resources, and network throughput capability to handle the necessary workload placed upon it. FIG. 6 illustrates, a typical computer system suitable for implementing one or more embodiments disclosed herein. The general-purpose computer system 700 includes a processor 702 (which may be referred to as a central processor unit or CPU) that is in communication with memory devices including secondary storage 708, read only memory (ROM) 710, random access memory (RAM) 712, input/output (I/O) device 706, and network connectivity devices 704. The processor 702 may be implemented as one or more CPU chips.

The secondary storage 708 typically includes one or more disk drives or tape drives and is used for non-volatile storage of data and as an over-flow data storage device if RAM 712 is not large enough to hold all working data. Secondary storage 708 may be used to store programs that are loaded into RAM 712 when such programs are selected for execution. The ROM 710 is used to store instructions and perhaps data that are read during program execution. ROM 710 is a non-volatile memory device that typically has a small memory capacity relative to the larger memory capacity of secondary storage. The RAM 712 is used to store volatile data and perhaps to store instructions. Access to both ROM 710 and RAM 712 is typically faster than to secondary storage 708.

I/O devices 706 may include printers, video monitors, liquid crystal displays (LCDs), touch screen displays, keyboards, keypads, switches, dials, mice, track balls, voice recognizers, card readers, paper tape readers, or other well-known input devices. The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity devices 704 may enable the processor 702 to communicate with an Internet or one or more intranets. With such a network connection, it is contemplated that the processor 702 might receive information from the network, or might output information to the network in the course of performing the above-described method steps. Such information, which is often represented as a sequence of instructions to be executed using processor 702, may be received from and outputted to the network, for example, in the form of a computer data signal embodied in a carrier wave.

Such information, which may include data or instructions to be executed using processor 702 for example, may be received from and outputted to the network, for example, in the form of a computer data baseband signal or signal embodied in a carrier wave. The baseband signal or signal embodied in the carrier wave generated by the network connectivity devices 704 may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 702 executes instructions, codes, computer programs, scripts that it accesses from hard disk, floppy disk, optical disk (these various disk based systems may all be considered secondary storage 708), ROM 710, RAM 712, or the network connectivity devices 704.

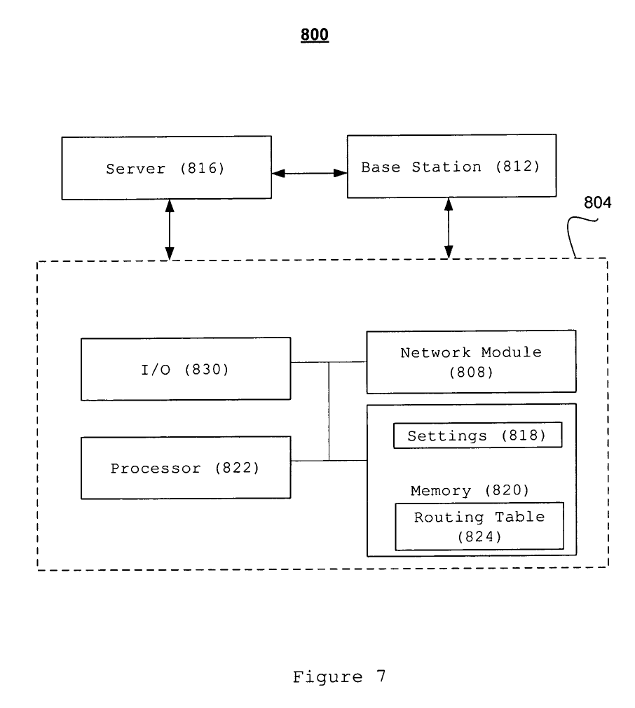

FIG. 7 is a block diagram illustrating one M2M device system 800. The M2M device system 800 includes a M2M router 804. The M2M router 804 includes a processor 822, a wireless network module 808 (such as a GSM/GPRS/EDGE modem), memory 820, and an input output device (I/O) 830. I/O device 830 may comprise a local area network device such as a wired Ethernet connection or a wireless local area connection. The memory 820 may include store various settings 818 and a routing table 824, including rules relating to how to route application data 232 with specific types of data types or data attributes. The M2M router 804 may include a real-time clock and other components for providing additional functionality.

Settings 818 may be used to store elements relating to the configuration of the M2M router 112, including security protocols. Routing table 824 may be used to store instructions relating to how and what destinations certain types of data should be routed to, as illustrated above in Table 1.

The M2M device system 800 may also include various remote communications devices, such as a base station 812 and a host server 816. The M2M device system 800 may further include any number of other connections to other systems and networks.

The wireless network module 808 provides wireless communication functionality between the M2M router 804 and the base station 812 and/or host server 816, to a remote device (e.g., host server 816). The wireless network module 808 in the M2M router 804 may utilize any wireless technology including, but not limited to, code division multiple access (CDMA), global system for mobile (GSM) communications, worldwide interoperability for microwave access (WiMAX), or any other wireless standard. Through the wireless network module 808 modem, the M2M router 804 is able to communicate with other remote communication devices via an air interface.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other products shown or discussed as directly coupled or communicating with each other may be coupled through some interface or device, such that the products may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

It should be understood that although an exemplary implementation of one embodiment of the present disclosure is illustrated above, the present system may be implemented using any number of techniques, whether currently known or in existence. The present disclosure should in no way be limited to the exemplary implementations, drawings, and techniques illustrated above, including the exemplary design and implementation illustrated and described herein, but may be modified within the scope of the appended claims along with their full scope of equivalents.

We claim:

1. A system, comprising:
A router in communication with a device, wherein the router is programmed to route data from the device based upon the contents of the data from the device, and wherein the router is interprets the application data as one of wakeup, attention request, attention response, modem event, or other data; and
a server in communication with the router, wherein the M2M router receives a packet from the device and routes the packet based upon the interpreted application data comprised within the packet to the server.

2. The system of claim 1, wherein the M2M router routes categorized application data according to a preprogrammed mode to at least one destination.

3. The system of claim 2, wherein preprogrammed mode is selected from the group: switch, copy, and split.

4. The system of claim 1, at least some of the packet is forwarded to a second server.

5. The system of claim 1, at least some of the packet is forwarded to a second M2M router.

6. The system of claim 1, wherein the categorized application data is encapsulated into a second packet prior to being routed by the M2M router.

7. The system of claim 1, wherein the M2M router is designed to transmit application data that is private to a secure server.

8. The system of claim 1, wherein the application data is embedded into user datagram protocol data.

9. The system of claim 1, wherein the application data is embedded into an internet protocol packet.

10. A routing device, comprising:
a memory;
a processor coupled to the memory and configured to execute a plurality of routing functions; and
a communication interface in the routing device, wherein the communication interface is coupled to the processor, and wherein the communication interface receives a packet of information from a remote device and routes the application data within the packet to a remote server based on application data in the packet.

11. The apparatus of claim 10, wherein the memory is stores a routing table.

12. The apparatus of claim 10, wherein the application data comprises position information.

13. The apparatus of claim 11, wherein the M2M router strips any routing information embedded in the packet of information from the M2M device.

14. A method, comprising:
receiving a internet protocol (IP) packet;
analyzing the application data layer of the IP packet;
categorizing the packet, wherein the category of the packet is determined by comparing the analyzed contents of the packet against a list of known categories of packets;
identifying a routing rule that corresponds to the determined category of the packet; and
routing the packet.

15. The method of claim 14, wherein the routing of the packet corresponds to a preprogrammed mode.

16. The method of claim 15, wherein preprogrammed mode is selected from the group: switch, copy, and split.

17. The method of claim 15, wherein the categorized packet is routed to a secure server.

18. The method of claim 15, wherein the categorized packet is routed to a M2M device.

19. The method of claim 15, wherein the at least part of the categorized packet is routed to a M2M device and at least part of the categorized packet is routed to a secure server.

20. The system of claim 15, wherein the packet is received from a M2M device.
